(19) United States
(12) Patent Application Publication
(10) Pub. No.: US 2006/0216537 A1
(43) Pub. Date: Sep. 28, 2006

(54) Coating paper which can be removed by water and a method for preparation thereof

(76) Inventors: Junpei Natsui, Tokyo (JP); Akihito Ogino, Tokyo (JP); Hiroki Midorikawa, Tokyo (JP); Yoshiaki Ishino, Fuji-shi (JP); Yoshiteru Kanomata, Fuji-shi (JP)

Correspondence Address: FLYNN THIEL BOUTELL & TANIS, P.C., 2026 RAMBLING ROAD, KALAMAZOO, MI, 49008-1631, US

(21) Appl. No.: 11/385,295

(22) Filed: Mar. 21, 2006

(30) Foreign Application Priority Data
Mar. 22, 2005 (JP) 2005-082299
Jun. 1, 2005 (JP) 2005-161596

(51) Int. Cl. B32B 29/00

(52) U.S. Cl. 428/537.5; 162/135; 162/136; 162/137; 162/146; 162/123

(57) ABSTRACT

A coating paper which can be removed by water comprising a substrate paper of single layer or lamellar structure having two or more layers which has at least one water decaying layer containing 5-100 wt % of water insoluble fibrous carboxy alkyl cellulose and a water base color is coated on said substrate paper, wherein a coating layer and at least a part of substrate paper which is a supporter of said coating layer has a characteristic of easily removing, dispersion and dissolving by contact with water, and can provide a water decaying coating paper used preferably for an use of label for a returnable container which may easily remove by contact with water and excellent in printing aptitude and a method for preparation thereof can be provided.

### BACK GROUND OF THE INVENTION

1. Field of the Invention

The present invention relates to a coating paper providing a coating layer on a substrate paper which easily causes swelling, disperses or dissolves by contact with water and a method for preparation thereof, and an adhesive sheet providing an adhesive layer on a non-coating surface of said coating paper. More in detail, the present invention is a coating paper prepared by providing a coating layer having a characteristic for various printing methods such as offset printing, gravure printing, thermal recording method, ink-jet recording method or laser beam printing method on a substrate paper characterized at least a part may swell, disperse or dissolve by water, which can be preferably used for an use such as a label for a returnable container utilizing a special feature that a coating layer is easily come off caused by removing of a part of paper or by dispersion or by dissolving, further relates to a method for preparation of said coating paper.

2. Description of the Prior Art

Recently an environmental problem is becoming the object of public interest, and a returnable container is broadly paid attention. Generally, to a returnable container, an adhesive label having an adhesive layer to rear surface of a coating paper on the surface of which letters or patterns are printed. However, after used, said label should be removed (released) from the container, and complicated washing work is necessary. For the purpose to make said removing work easy, investigations to improve removing (releasing) ability of label by using water soluble adhesive to an adhesive layer are carried out, however, in this case, since a coating layer and a substrate paper prevent water from entering into an adhesive layer, remarkable effect can not be accomplished.

To dissolve said problem, a water decaying adhesive sheet characterized by providing a coating layer suited for various recording systems on a substrate paper prepared by using water soluble material or water dispersible material and providing an adhesive layer on an non-coating layer is disclosed in Patent Document 1.

The construction of a water decaying thermally sensitive recording sheet disclosed in Patent Document 1 and a water decaying adhesive sheet which uses said water decaying thermally sensitive recording sheet is characterized by providing a specific filling layer and a coating layer (thermally sensitive recording layer) on water soluble or water dispersible substrate paper and providing an adhesive layer on a non-coating layer, and make it possible to remove a label easily from a returnable container by using water soluble paper or water dispersible paper as a substrate paper. In the present invention, water soluble paper is a paper which has a feature to disperse fibrously in water within very small time of 5-20 seconds and partially dissolves in water, and a method for preparation is disclosed in Patent Documents 2 and 3. That is, various additives (filler, sizing agent, dye or pigment) are added to water soluble fibers if necessary and can be prepared by ordinary paper making method. Said water soluble paper is not only actually used as a printing paper or a writing paper, but also used as a water soluble adhesive label or a water soluble bag by providing adherence or heat sealing ability by carrying out secondary processing such as coating, adhering or laminating. Further, in the present invention, water dispersible paper is a paper which has a characteristic to disaggregate in water and become small fragments, and is mainly used as a toilet tissue which can be disposed in a flush toilet after used.

Further, in general, in a case when a coating liquid consisting of aqueous solution of water soluble resin or water dispersion of water insoluble resin is coated on a substrate paper made of water soluble paper or water dispersible paper using bar coater method, knife coating method, roll coating method, blade coating method, die coating method or gravure coating method then dried, water soluble paper or water dispersible paper, which is a substrate paper, has a tendency to swell excessively and cause a problem to break in a coating machine.

To dissolve said problem, in Patent Document 1, following methods are disclosed. That is, (1) forming a filling layer by coating and drying a water soluble resin or a water dispersible resin dissolved inorganic solvent by public known method such as bar coater method utilizing features that water soluble paper or water dispersible paper do not disperse or dissolve in organic solvent. (2) Forming a water soluble filling layer using a water soluble resin which can apply an extrusion method using an extrusion molding machine, further forming a filling layer composed of water insoluble resin on the water soluble filling layer.

However, a water decaying thermally sensitive recording sheet and a water decaying adhesive sheet using said water decaying thermally sensitive recording sheet disclosed in Patent Document 1 has a problem that the manufacturing cost becomes high because expensive organic solvent is used and an additional coating process besides coating process of a coating layer (thermally sensitive recording layer) is necessary. Further, decaying feature of a filling layer formed by coating an organic solvents coating using water soluble resin or water dispersible resin which can dissolve inorganic solvent is inferior when compared with that of water soluble paper or water dispersible paper used as a substrate material or with that of coating layer provided on a substrate paper, therefore, when washed by water it removes in film state and causes a problem to stuff a drainpipe.

Further, in Patent Document 4, a water dispersible sheet formed by providing a coating layer on a substrate paper of water soluble paper or water dispersible paper is disclosed, however, said sheet is not sufficient in decaying feature by water in suited grammage region as a substrate paper of coating paper.

As mentioned above, a coating paper which has both good decaying feature by water and characteristic as a coating paper (printing aptitude) and a method for preparation are not accomplished yet.
Patent Document 1: JP2004-314623A Publication
Patent Document 2: Japanese Patent S43-1214 Publication
Patent Document 3: Japanese Patent S48-27605 Publication
Patent Document 4: JPH09-49188A Publication

### SUMMARY OF THE INVENTION

The object of this invention is to provide a coating paper which can be removed (released) easily by contact with water, having excellent printing aptitude, characterized to have a feature that at least a part of a coating layer and a substrate paper easily causes swelling, dispersion or dissolution when contacted with water and suited for the use of a label for a returnable container, and is to provide a method for preparation of said coating paper.

The inventors of the present invention have continued an eager investigation to dissolve said object, and found out following fact. That is, in a coating paper prepared by coating a water base color on a substrate paper of single layer or of lamellar structure having two or more layers which has at least one water decaying layer containing 5-100 wt % of water insoluble fibrous carboxyalkyl cellulose, it is very important to contain an alkalizing agent in said substrate paper and accomplished present invention. Further, the inventors of the present invention have found that to coat a water base color on one surface of substrate paper composed of lamellar structure of single layer or of lamellar structure having two or more layers of said water decaying layer and to contain an alkalizing agent from non-coating surface is very important for the method for preparation, and accomplished the present invention.

Especially, when grammage of a substrate paper is 50 g/m² or more, a coating layer which is excellent in printing aptitude and can be preferably used for a label for a returnable container can be obtained by using a substrate paper of single layer or of lamellar structure having two or more layers which has at least one layer containing 30-60 wt % of fibrous carboxy alkyl cellulose and 40-70 wt % of water dispersible fibers for paper manufacturing beaten to 550-650 mlCSF measured by Canadian standard freeness.

According to the present invention, a coating layer and at least a part of substrate paper which is a supporter of said coating layer has a characteristic of easily removing, dispersion and dissolving when contacts with water, and can provide a water decaying coating paper used preferably for an use of label for a returnable container which may easily remove by contact with water and excellent in printing aptitude and a method for preparation thereof can be provided.

### DESCRIPTION OF THE PREFERRED EMBODIMENT

The coating paper which can be removed by water of the present invention, as the first step, forms a coating layer which is suited for various printing methods by coating and drying a water base color liquid on a substrate paper containing water insoluble fibrous carboxy alkyl cellulose. The substrate paper containing water insoluble fibrous carboxy alkyl cellulose is insoluble in water and does not cause excess swelling by water, therefore, does not cause breaking problem based on the deterioration of a substrate paper at the coating process. And by containing an alkalizing agent in the coating paper, acidic carboxy alkyl group of fibrous carboxy alkyl cellulose and the alkalizing agent are reacted and forms an alkali salt of water soluble fibrous carboxy alkyl cellulose.

According to above mentioned processes, a coating paper which can be removed by water of the present invention having a coating layer suited to various printing system on a substrate paper which disperses dissolves in water can be obtained.

Water insoluble fibrous carboxy alkyl cellulose contained in a substrate paper of the present invention can be obtained by carboxy alkalization of natural cellulose fibers, regenerated cellulose fibers or refined cellulose fibers by public known method, and as a specific example, fibrous carboxy methyl cellulose (CMC) or fibrous carboxy ethyl cellulose can be mentioned.

Further, the substituted degree of carboxy alkyl group of fibrous carboxy alkyl cellulose is 0.2-1.2, desirably, is 0.4-0.6. When the substituted degree is smaller than 0.2, even if exchanged to carboxy alkyl cellulose salt by an alkalizing agent, swelling or water dissolving ability to water is too low, and layer removing ability, dispersing ability and dissolving ability becomes insufficient. Further, when the substituted degree excesses 1.0, even if acidic carboxy alkyl group which is hard to dissolve in water, it becomes easily swelled by water, and since intensity of substrate paper is deteriorated, possibility to cause problems such as breaking at coating of water base color becomes high.

In a substrate paper of the present invention, water insoluble fibrous carboxy alkyl cellulose, which is necessary component, and other water dispersible fibers used for paper manufacturing can be used together with. As a water dispersible fibers used for paper manufacturing, woody pulp fibers or non woody pulp fibers, for instance, woody pulp fibers such as conifer kraft pulp, broadleaf tree kraft pulp, dissolved pulp or mercerized pulp, non woody pulp fibers such as flaxen pulp, Manila linen pulp or Kenaf pulp or refined cellulose fibers such as Lyocell can be mentioned. As the average fiber length of water dispersible fibers for paper manufacturing, of 0.1-5 mm is preferably used, desirably, is 0.5-3 mm, more desirably, is 0.8-2 mm.

It is desirable to use water dispersible fibers for paper manufacturing by beating to 250-700 mlCSF measured by Canadian standard freeness, desirably to 550-650 mlCSF. In a case when beaten until Canadian standard freeness becomes smaller than 250 mlCSF, fibrilization of fiber, breaking and inner swelling increase, and density of substrate paper, intensity and smoothness are improved, therefore, physical property suited for formation of a coating layer can be obtained, however, water dispersing ability becomes insufficient. On the contrary, when beating degree is too low, water dispersing ability becomes good, however, intensity and smoothness becomes insufficient and becomes porous, and is not suited for the formation of a coating layer. Therefore, the degree of beating which satisfies both water dispersing ability and aptitude as a substrate paper for coating is 250-700 mlCSF and desirably is 550-650 mlCSF.

Blending ratio of fibrous carboxy alkyl cellulose to a substrate paper is 5-100 wt %, desirably is 30-60 wt %. In a case that blending ratio of fibrous carboxy alkyl cellulose is less than 5 wt %, water swelling or water dispersible ability after an alkalizing agent is coated becomes insufficient and is not desirable.

The substrate paper can be formed as a single layer construction containing fibrous carboxy alkyl cellulose as a necessary component, however, it is possible to form a multi layer lamellar structure having 2 or more layers whose blending ratio of fibrous carboxy alkyl cellulose are different.

In the present invention, as a substrate paper containing water insoluble fibrous carboxy alkyl cellulose, a paper of grammage of 10-200 g/m² can be used. In particular, for a substrate paper as a coating paper for printing, a paper of grammage larger than 50 g/m², desirably of grammage 50-120 g/m² can be suitably used.

Further, in a case when lamellar structure substrate is used, grammage of each layer is 5-100 g/m², desirably is 10-100 g/m², furthermore, it is desirable that a layer which contains 5 wt % or more, desirably 30 wt % or more fibrous carboxy cellulose, to be 50 wt % or more to total grammage of the substrate paper.

In the present invention, any kind of coating layer, which is formed by coating and drying a water base color, can be used and is not particular about single layer or multi layers, and a method for coating is not particularly restricted. Further, materials composing a coating layer can be voluntarily chosen along with a printing method (offset printing or gravure printing) or other printing method (ink jet printer, thermal printer or laser beam printer).

In the present invention, it is necessary to coat a coating layer having a characteristic suited to various printing methods on a substrate paper containing above mentioned fibrous carboxy alkyl cellulose. The composition of this coating layer is not restricted and can be a single layer or a multi layer having 2 or more layers. And as materials used for a coating layer, public known materials can be used. Examples of a coating layer suited to a thermal printer, an ink jet printer and a gravure printing are indicated as follows.

a) Coating Layer Fitted to a Thermal Printer

In a case to make fit a coating paper which can be removed by water of the present invention to a printing method by a thermal printer, it is desirable to coat an undercoat layer containing a dye and a binder as main components and a thermally sensitive recording layer containing colorless or pale colored electron-donating leuco dye and electron-accepting color developing agent as main components on the substrate paper in order. Since abovementioned substrate paper possessing a porous layer (adiabatic effect is high) containing fibrous carboxy cellulose, residue and sticking are improved.

Smoothness of surface of substrate paper on which an undercoat layer is coated is not restricted, however, in general, surface of high smoothness is desired, and a surface contacted to a Yankee dryer or a calendaring treated surface is suitably used.

An undercoat layer is coated for the purpose to enhance surface smoothness of substrate paper surface so as to accomplish sharpness and high sensitivity of a recorded image, and can use public known filling agent, binder and various additives by voluntarily selection. If an undercoat layer is not provided, a substrate paper containing an alkalizing agent contacts directly with a thermally sensitive recording layer and may deteriorate color developing sensitivity, therefore, it is desirable to provide an undercoat layer.

As a filler for the undercoat layer, an inorganic filler such as silica, calcium carbonate, clay, kaolin, calcined kaolin, diatomaceous earth, talc, titanium oxide, aluminum hydroxide, magnesium carbonate, zinc oxide, aluminum oxide, magnesium hydroxide, barium sulfate, calcium sulfate, zinc sulfate, calcium silicate, aluminum silicate, magnesium silicate, sodium aluminosilicate, magnesium aluminum silicate or an organic filler such as melamine resin, urea-formalin resin, polyethylene powder or nylon powder can be mentioned.

In an undercoating layer, public known binder can be used. As a specific example, full saponificated polyvinyl alcohol, partial saponificated polyvinyl alcohol, carboxyl denatured polyvinyl alcohol, amide denatured polyvinyl alcohol, sulfonic acid denatured polyvinyl alcohol, butylal denatured polyvinyl alcohol, other denatured polyvinyl alcohol, hydroxyethyl cellulose, methyl cellulose, carboxy methyl cellulose, starches, gelatin, casein, sodium alginate, polyvinylpyrrolidone, polyacrylicamide, copolymer of acrylicamide/acrylic ester, alkaline salt of styrene/maleic acid anhydride, water soluble resin such as alkaline salt of ethylene/maleic acid anhydride, copolymer of styrene/butadiene, copolymer of acrylonitrile/butadiene, copolymer of acrylic methyl/butadiene, ternary copolymer of acrylonitrile/butadiene/styrene, cellulose derivatives such as ethylcellulose, acetylcellulose, water insoluble resin such as polyvinyl chloride, polyvinyl acetate, copolymer of vinyl acetate/acrylate, poly acrylate, copolymer of styrene/acrylate, polyurethane resin, polyvinylbutyral polystyrol and copolymer thereof, polyamide resin, silicone resin, petroleum resin, terpene resin, ketone resin and cumarone resin can be mentioned. These polymer compound are used by dissolving in solvent such as water, alcohol, ester or ketone, ester or hydrocarbon, further can be used by emulsified state or past state dispersed in water or other medium and can be used according to the required quality. From the view point of removing (releasing) ability by water, it is desirable to use starches, hydroxyethyl cellulose, methyl cellulose, carboxy methyl cellulose, gelatin, casein, sodium alginate, polyvinyl alcohol, denatured polyvinyl alcohol or polyvinylpyrrolidone as a main component of a binder.

In general, content of a binder in an undercoat layer is 5-100 wt parts by solid to 100 wt parts of filler.

To an undercoat layer, various additives which are usually used can be used together with besides a filler and a binder. As various additives, a dispersing agent for dye, a defoaming agent, a lubricant, an UV absorbing agent, a sizing agent, a sensitizer, a fluorescence dye or a preservatives can be mentioned.

An undercoat layer can be obtained by coating a coating prepared by dispersing and mixing said filler, binder and other additives forming single layer or multi layer using a coating machine and heating and drying by a dryer.

Coating amount of the coating by dry weight is ordinary 0.5-50 g/m², desirably 3-15 g/m2. As a coating machine, air knife coater, bar coater, roll coater, blade coater curtain coater, champflex coater or gravure coater can be mentioned.

In a thermally sensitive recording layer to be coated on an undercoat layer, public known leuco dyes can be used by alone or can be used together with, especially, leuco compounds of triphenylmethane dyes, fluorane dyes, phenothiazine dyes, auramine dyes, spiropyrane dyes or indolinophthalide dyes are desirably used. As a specific example,
3,3-bis(p-dimethylaminophenyl)phthalide,
3,3-bis(p-dimethylaminophenyl)-6-dimethylaminophthalide (another name; Crystal Violet Lacton),
3,3-bis(p-dimethylaminophenyl)-6-diethylaminophthalide,
3,3-bis(p-dimethylaminophenyl)-6-chlorophthalide,
3,3-bis(p-dibutylaminophenyl)phthalide,
3-cyclohexylamino-6-chlorofluorane,
3-dimethylamino-5,7-dimethylfluorane,
3-diethylamino-7-chlorofluorane,
3-diethylamino-7-methylfluorane,
3-diethylamino-7,8-benzfluorane,
3-diethylamino-6-methyl-7-chlorofluorane,
3-(N-p-tolyl-N-ethylamino)-6-methyl-7-anilinofluorane,
3-pyrroridino-6-methyl-7-anilinofluorane,
2-{N-(3′-trifluoromethylphenyl)amino}-6-diethylaminofluorane,
2-{3,6-bis(diethylamino)-9-(o-chloroanilino)xanthilbenzoatelactam},
3-diethylamino-6-methyl-7-(m-trichloromethylanilino)fluorane,
3-diethylamino-7-(o-chloroanilino)fluorane,
3-di-7-butylamino-7-(o-chloroanilino)fluorane,
3-N-methyl-N,n-amylamino)-6-methyl-7-anilinofluorane,
3-N-methyl-N-cyclohexylamino)-6-methyl-7-anilinofluorane,
3-diethylamino-6-methyl-7-anilinofluorane,
3-(N,N-diethylamino)-5-methyl-7-(N,N-dibenzylamino)fluorane, benzoylleucomethyleneblue,
6′-chloro-8′-methoxy-benzoindolino-spiropyrane,
6′-bromo-3′-methoxy-benzoindolino-spiropyrane,
3-(2′-hydroxy-4′-dimethylaminophenyl)-3-(2′-methoxy-5′-chlorophenyl)phthalide,
3-(2′-hydroxy-4′-dimethylaminophenyl)-3-(2′-methoxy-5′-nitrophenyl)phthalide,
3-(2′-hydroxy-4′-diethylaminophenyl)-3-(2′-methoxy-5′-methylphenyl) phthalide,
3-(2′-metoxy-4′-dimethylaminophenyl)-3-(2′-hydroxy-4′-chloro-5′-methylphenyl)phthalide,
3-(N-ethyl-N-tetrahydrofurfuryl)amino-6-methyl-7-anilinofluorane,
3-N-ethyl-N-(2-ethoxypropyl)amino-6-methyl-7-anilinofluorane,
3-N-methyl-N-isobutyl-6-methyl-7-anilinofluorane,
3-morpholino-7-(N-propyl-trifluoromethylanilino)fluorane,
3-pyrrolidino-7-m-trifluoromethylanilinofluorane,
3-diethylamino-5-chloro-7-(N-benzyl-trifluoromethylanilino)fluorane,
3-pyrroridino-7-(di-p-chlorophnyl)methylaminofluorane,
3-diethylamino-5-chloro-7-(α-phenylethylamino)fluorane,
3-(N-ethyl-p-toluidino)-7-(α-phenylethylamino)fluorane,
3-diethylamino-7-(o-methoxycarbonylphenylamino)fluorane,
3-diethylamino-5-methyl-7-(α-phenylethylamino)fluorane,
3-diethylamino-7-piperidinofluorane,
2-chloro-3-(N-methyltoluidino)-7-(p-n-butylanilino)fluorane,
3-(N-methyl-N-isopropylamino)-6-methyl-7-anilinofluorane,
3-di-n-butylamino-6-methyl-7-anilinofluorane,
3,6-bis(dimethylamino)fluorenespiro(9,3′)-6′-dimethylaminophthalide,
3-(N-benzyl-N-cyclohexylamino)-5,6-benzo-7-α-naphtylamino-4′-buromofluorane,
3-diethylamino-6-chloro-7-anilinofluorane,
3-diethylamino-6-methyl-7-mesitydino-4′,5′-benzofluorane,
3-N-methyl-N-isopropyl-6-methyl-7-anilinofluorane,
3-N-ethyl-N-isoamyl-6-methyl-7-anilinofluorane,
3-diethylamino-6-methyl-7-(2′,4′-dimethylanilino)fluorane.

Since a coating paper which can be removed by water of the present invention has a possibility to be drawn to a drain after use, affect to an environmental matter should be considered. Therefore, among these compounds, following compounds can be mentioned and can be used as a safety dye;
3-diethylamino-6-methyl-7-anilinofluorane,
3-dibutylamino-6-methyl-7-anilinofluorane,
3-(N-cyclohexyl-N-amino)-6-methyl-7-anilinofluorane,
3-(N-ethyl-N-isopentylamino)-6-methyl-7-anilinofluorane,
3-N-di-n-pentylamino-6-methyl-7-anilinofluorane,
3-diethylamino-7-(3-trifluoromethylanilino)fluorane,
3-(N-ethyl-N-4-methylphenylamino)-6-methyl-7-anilinofluorane,
3-diethylamino-6-methyl-7-(3-methylanilino)fluorane,
3,3′-bis(dimethylaminophenyl)-6-dimethylaminophthalide,
3-(4-diethylamino-2-ethoxyphenyl)-3-(1-ethyl-2-methylindole-3-yl)-4-azaphthalide,
2-(N-phenyl-N-methylamino)-6-(N-p-tolyl-N-ethylamino)fluorane,
3,3-bis(1-n-butyl-2-methyl-indole-3-yl)phthalide,
1,3-dimethyl-6-diethylaminofluorane and 3-bromo-3-methyl-6-dibutylaminofluorane

As a color developing agent which is contained in a thermally sensitive recording layer with a leuco dye, phenols, organic acids, inorganic acids and esters or salts thereof can be used. As a specific example, gallic acid, salicylic acid, 3-isopropylsalicilate, 3-cyclohexylsalicilate, 3,5-di-tert-butylsalicilate, 3,5-di-α-methylbenzylsalicilate, 4,4′-isopropylidenediphenol, 1,1′-isopropylidenebis(2-chlorophenol), 4,4′-isopropylinebis(2,6-dibromophenol), 4,4′-isopropylidenebis(2,6-dichlorophenol), 4,4′-isopropylidenebis(2-methylphenol), 4,4′-isopropylidenebis(2,6-dimethylphenol), 4,4-isopropylidenebis(2-tert-butylphenol), 4,4′-sec-butylidenediphenol, 4,4′-cyclohexylidenebisphenol, 4,4′-cyclohexylidenebis(2-methylphenol), 4-tert-butylphenol, 4-phenylphenol, 4-hydroxydiphenoxide, α-naphthol, β-naphthol, 3,5-xylenol, thymol, methyl-4-hydroxybenzoate, 4-hydroxyacetophenon, novolac phenol resins, 2,2′-thiobis(4,6-dichlorophenol), catechol, resorcin, hydroquinone, pyrogallol, phloroglycine, phloroglycine carboxylic acid, 4-tert-octylcatecol, 2,2′-methylenebis(4-chlorophenol), 2,2′-methylenebis(4-methyl-6-tert-butylphenol), 2,2′-dihydroxydiphenyl, p-hydroxyethylbenzoate, p-hydroxypropylbenzoate, p-hydroxybutylbenzoate, p-hydroxybenzylbenzoate, p-chlorobenzy-p-hydroxybenzoate, o-chlorobenzy-p-hydroxybenzoate, p-methylbenzyl-p-hydroxybenzoate, n-octyl-p-hydroxybenzoate, benzoic acid, zincsalicilate, 1-hydroxy-2-naphthoic acid, 2-hydroxy-6-naphthoic acid, zinc2-hydroxy-6-naphthoate, 4-hydroxydiphenylsulfone, 4-hydroxy-4′-chlorodiphenylsulfone, bis(4-hydroxyphenyl)sulfide, 2-hydroxy-p-toluic acid, zinc3,5-di-tert-butylsalicilate, tin3,5-di-tert-butylsalicilate, tartalic acid, oxalic acid, maleic acid, citric acid, succinic acid, stearic acid, 4-hydroxyphthalic acid, boric acid, thiourea derivatives, 4-hydroxythiophenol derivatives, bis(4-hydroxyphenyl)acetic acid, ethylbis(4-hydroxyphenyl)acetate, n-propylbis(4-hydroxyphenyl)acetate, n-butylbis(4-hydroxyphenyl)acetate, phenylbis(4-hydroxyphenyl)acetate, benzylbis(4-hydroxyphenyl)acetate, phenethylbis(4-hydroxyphenyl)acetate, bis(3-methyl-4-hydroxyphenyl)acetic acid, methylbis(3-methyl-4-hydroxyphenyl)acetate, propylbis(3-methyl-4-hydroxyphenyl)acetate, 1,7-bis(4-hydroxyphnylthio)3,5dioxaheptane, 1,5-bis(4-hydroxyphenylthio)3-oxa-pentane, dimethyl-4-hydroxyphthalate, 4-hydroxy-4′-methoxydiphenylsulfone, 4-hydroxy-4′-ethoxydiphenylsulfone, 4-hydroxy-4′-isopropoxydiphenylsulfone, 4-hydroxy-4′-propoxydiphenylsulfone, 4-hydroxy-4′-butoxydiphenylsulfone, 4-hydroxy-4′-isobutoxydiphenylsulfone, 4-hydroxy-4′-sec-butoxydiphenylsulfone, 4-hydroxy-4′-tert-butoxydiphenylsulfone, 4-hydroxy-4′-benzyloxydiphenylsulfone, 4-hydroxy-4′-phenoxydiphenylsulfone, 4-hydroxy-4′-(m-methylbenzyloxy)diphenylsulfone, 4-hydroxy-4′-(p-methylbenzyloxy)diphenylsulfone, 4-hydroxy-4′-(o-methylbenzyloxy)diphenylsulfone and 4-hydroxy-4′-(p-chlorobenzyloxy)diphenylsulfone can be mentioned.

Since a coating paper which can be removed by water of the present invention has a possibility to be drawn to a drain after use, affect to an environmental matter should be considered. Therefore, following compounds can be mentioned and can be used as the most safe color developing agent; 4,4′-dihydroxydiphenylsulfone, 2,4′-dihydroxydiphenylsulfone, 4-hydroxy-4′-isopropoxydiphenylsulfone, benzylparahydroxybenzoate, 4-hydroxy-4′-propoxydiphenylsulfone, 3-{[(phenylamino)carbonyl]amino}benzenesulfoneamide, N-(4′-hydroxyphenylthio)acetyl-2-hydroxyaniline, 1:1 mixture of N-(4′-hydroxyphenylthio)acetyl-4-hydroxyaniline and N-(4′-hydroxyphenylthio)acetyl-2-hydroxyaniline, 4,4′-bis(3-(phenoxycarbonylamino)methylphenylureido) diphenylsufone, color developing agent containing 55% of 2,2′-bis[4-(4-hydroxyphenyl sulfone)phenoxy]diphenylether, condensation compound containing 55% of 2′-methylenebis (4-t-butyl phenol) {that is, containing 55% of 2,2′-methylenebis (4-t-butylphenol) and remaining is a condensation compound consisting of tri-nuclear condensation compound (29%), tetra-nuclear condensation compound (11%) and penta-nuclear condensation compound (4%) which is corresponding thereto and others is 1%}.

As a binder to be used in a thermally sensitive recording layer, same sorts of binder used in afore mentioned undercoating layer can be used, however, not limited to them. From the view point of removing ability by water, it is desirable to use starches, hydroxyethyl cellulose, methyl cellulose, carboxymethyl cellulose, gelatin, casein, sodium alginate, polyvinyl alcohol, denatured polyvinyl alcohol or polyvinylpyrrolidone as a main component of a binder.

In the thermally sensitive recording layer, a supplemental additive component, for example, sensitizer, filler, stabilizer such as metallic salt of p-nitrobenzoic acid (Ca, Zn) or metallic salt of phthalic acidmonobenzyl ester (Ca, Zn), parting agent such as metallic salt of fatty acid, slipping agent such as waxes, inhibitor for pressure coloring, ultra violet ray absorbing agent, water resisting agent such as glyoxal, dispersing agent or defoaming agent can be used when a need is arisen.

As a sensitizer which improve thermal responsibility, thermal fusible compound is used, and thermal fusible organic compound whose melting point is 50-200° C. can be mentioned. As a specific example, stearic acid amide, palmitic acid amide, N-hydroxymethyl stearic acid amide, N-stearyl stearic acid amide, ethylene-bis-stearic acid amide, N-stearylurea, benzyl-2-naphthylether, m-tarphenyl, 4-benzylbiphenyl, 2,2′-bis(4-methoxyphenoxy)diethylether, α,α′-diphenoxyxylene, bis(4-methoxyphenyl)ether, diphenyladipate, dibenzyloxalate, di(4-chlorobenzyl)oxalate, dimethylterephthalate, dibenzylterephthalate, phenylbenzensulfonate, bis(4-allyloxyphenyl)sulfone, 4-acetylacetophenon, aceto acetic acid anilides, fatty acid anilides, montan waxes, polyethylene wax, benzyl p-benzyloxybenzoate, di-p-tolylcarbonate, phenyl-naphthylcarbonate, 1,4-diethoxynaphthalene, phenyl 1-hydroxy-2-naphthoate, 1,2-di-(3-methylphenoxy)ethane, di(p-methylbenzyl)oxalate, benzyloxy naphthalene, 4-biphenyl p-tolylether, o-xylene-bis-(phenylether) or 4-(m-methylphnoxymethyl)biphenyl can be mentioned.

Since a coating paper which can be removed by water of the present invention has a possibility to be drawn to a drain after use, affect to an environmental matter should be considered. Therefore, among these compounds, following compounds can be mentioned and can be used as a safety sensitizer; stearic acid amide, palmitic acid amide, ethylene-bis-stearoamide, benzyl-para-benzyloxybenzoate, 4-biphenyl-para-tolylether, bis(paramethylbenzyl)oxalate, bis(parachlorobenzyl)oxalate, parabenzylbiphenyl, 1,2-bis(phenoxymethyl)benzene, para-toluenesulfoneamide, ortho-toluenesulfoneamide, diphenylsulfone, benzyloxynaphthalene, para-phenylacetophenone or 1,2-di-(3-methylphenoxy)ethane can be desirably used.

As a filler, same sorts of compounds used as a binder used in afore mentioned undercoating layer can be used.

Amount of organic color developing agent and leuco dye, sort and amount of other components are decided according to the required physical properties and recording aptitude and not to be limited, however, in general, 0.5-10 weight parts of organic color developing agent, 0.5-10 weight parts of sensitizer to 1 parts of leuco dye are used, and regarding a filler, 5-50 weight % to total solid amount is suitable.

Above mentioned organic color developing agent, leuco dye and other materials to be added when need is arisen, are pulverized to particle size of several micron or less using a pulverizing machine such as ball mill, attriter or sand grinder, or by means of an adequate emulsifying apparatus, then a binder and various sort of additives are added according to the purpose and a coating is prepared.

Forming method of a thermally sensitive recording layer is not limited, and a thermally sensitive recording layer is formed by a method to coat a coating on a substrate paper and to dry it, for example, air knife coating, rod blade coating, bar coating, blade coating, gravure coating or curtain coating. And coating amount of a coating is generally 2-12 g, desirably 3-10 g.

By providing a protective layer on a thermally sensitive recording layer, matching ability of a thermal head or preserving ability of a recorded image can be improved.

As a binder for a protective layer, the binder used for above mentioned thermally sensitive recording layer can be used and not restricted, however, from the viewpoint of removing ability by water, it is desirable to use starches, hydroxyethyl cellulose, methyl cellulose, carboxymethyl cellulose, gelatin, casein, sodium alginate, polyvinyl alcohol, denatured polyvinyl alcohol or polyvinylpyrrolidone as a main component of a binder.

As various additives to be used for a protective layer, filler, surface active agent, athermal fusible compound (or slipping agent) or an inhibitor for pressure coloring can be mentioned. In this case, as a specific example of a filler and a thermal fusible compound, same examples indicated in above mentioned thermally sensitive color developing layer can be used.

The protective layer can be obtained by coating a coating obtained by dispersing and mixing various additives to said binder by single layer or dividing to multi layer and by heat drying by a dryer.

Coating amount of the coating is ordinary 0.2-10 g/m², desirably 0.5-5 g/m² as the weight after dried. As coating machine to be used is not specifically limited, however, a public known coating machine such as air knife coater, bar coater, roll coater, blade coater, curtain coater, champflex coater or gravure coater can be used.

In the present invention, it is desirable to improve surface smoothness of thermally sensitive recording layer side of a thermally sensitive recording paper to which an alkalizing agent is contained using a smoothing apparatus such as calendar, supercalendar or soft nip calendar. It is desirable that the Beck smoothness is 50-2000 s, more desirably 100-2000 s. When Beck smoothness is less than 50 s, improvement of quality of printed letter is not sufficient and effect of smoothness treatment can not be obtained. And when Beck smoothness exceeds 2000 s deterioration of water dispersibility by improvement of density of substrate paper becomes remarkable, and is not desirable.

After forming an under layer on a smooth surface of water insoluble substrate paper, then a thermally sensitive recording layer, by impregnating alkalizing agent from a non-coating surface, a thermally sensitive recording paper having water removable ability can be obtained.

b) Coating Layer Fitted to an Ink Jet Printer

In a case to fit the water removing coating paper to printing by ink jet printer, it is desirable to form a pigment coating layer whose main components are pigment and water soluble binder or a clear coating layer whose main components are cationic resins and/or water soluble binder, and as a pigment, a binder and various additives, public known compounds can be used, further the amount of these compounds can be suitably decided according to the required quality. And, since this substrate paper has a porous layer (a layer which has high ink absorbing capacity) in which fibrous carboxy alkyl cellulose is contained, ink absorbing ability is improved.

As a pigment, same sorts of compounds used as a filler used in afore mentioned undercoating layer can be used, and not restricted, however, from the view point of ink absorbing ability and color developing ability, the use of silica, alumina, calcined kaolin or calcium carbonate is desirable.

As a binder, water soluble resin or water dispersible resin is desirable, and same sorts of compounds used as a binder used in afore mentioned undercoating layer can be used, and not restricted, however, from the view point of ink absorbing ability and color developing ability, the use of polyvinyl alcohol or modified polyvinyl alcohol is desirable.

As an additives, cationic resin (dye fixing agent), pigment dispersing agent, defoaming agent, lubricant, ultra violet ray absorbing agent, sizing agent, fluorescent dye or preservatives can be mentioned. In particular, since a cationic resin improves water resistance of image part and color developing ability, together use of a cationic resin is desirable.

As a coating machine, air knife coater, bar coater, roll coater, blade coater curtain coater, cast coater, champflex coater, gravure coater or transfer roll coater can be used.

After formation of a pigment coating layer using aqueous coating liquid or clear coating layer on a water insoluble substrate paper, by impregnating an alkalizing agent from non-coating surface, an ink jet recording paper having water removable ability can be obtained.

c) Coating Layer Fitted to a Gravure Printing

In a case to fit the water removing coating paper of the present invention to gravure printing, it is desirable to form a pigment coating layer whose main components are pigment and water soluble binder or a clear coating layer whose main components is water soluble binder, and as a pigment, a binder and various additives, public known compounds can be used, further the amount of these compounds can be voluntarily decided according to the required quality. And, since this substrate paper has a porous layer (a layer which has good cushion) in which fibrous carboxy alkyl cellulose is contained, ink adhering ability is improved.

As a pigment, same sorts of compounds used as a filler used in afore mentioned undercoating layer can be used, and not restricted.

As a binder, water soluble resin or water dispersible resin is desirable, and same sorts of compounds used as a binder used in afore mentioned undercoating layer can be used, and not restricted, however, from the view point of removing ability by water, it is desirable to contain starches, hydroxyethylcellulose; methylcellulose; carboxymethylcellulose, gelatin, casein, sodium alginate, polyvinyl alcohol, modified polyvinyl alcohol or polyvinyl pyrrolidone which are water dissolving resin as a binder.

As an additives, cationic resin (printing aptitude improving agent), pigment dispersing agent, defoaming agent, lubricant, ultra violet ray absorbing agent, sizing agent, fluorescent dye or preservatives can be mentioned.

As a coating machine, air knife coater, bar coater, roll coater, blade coater curtain coater, cast coater, champflex coater, gravure coater or transfer roll coater can be used.

After formation of a pigment coating layer using aqueous coating liquid or clear coating layer on a water insoluble substrate paper, by impregnate an alkalizing agent from non-coating surface, a paper for gravure printing can be obtained.

In the present invention, it is necessary to impregnate an alkalizing agent to a substrate paper on which a coating layer is coated. By impregnating an alkalizing agent to a substrate paper, water insoluble fibrous carboxy alkyl cellulose is converted to water soluble fibrous carboxy alkyl cellulose salt by neutralizing reaction, and the fibers in substrate paper becomes easy to swell and dissociate and becomes water dispersible. An alkalizing agent is an aqueous solution of alkaline compound, and as a specific example, hydroxide of alkali metal such as sodium hydroxide or potassium hydroxide, carbonate salt or hydrogen carbonate salt of alkali metal such as sodium carbonate or sodium hydrogen carbonate, phosphoric acid salt or phosphoric hydrogen acid salt such as sodium hydrogen phosphate, organic acid salt of alkali metal such as sodium acetate, hydroxide of alkali earth metal such as calcium hydroxide, ammonia and ammonium salt, amines such as ethanol amine or aqueous solution of polyethyleneimine whose molecular weight is 1000 or less can be mentioned.

The coating amount of these alkaline compound is necessary to be equal to a neutralizing equivalent of fibrous carboxy methyl cellulose in a substrate paper or more, desirably 1-3 times to a neutralizing equivalent or more. When the amount of alkaline compound is smaller than neutralizing equivalent, since water insoluble fibrous carboxy alkyl cellulose remains, sufficient water dispersibility can not be obtained, further carboxy alkyl cellulose bonds by themselves and the solubility deteriorates remarkably. Further, when the amount of alkaline compound exceeds 3 times of the neutralizing equivalent, problems of color change or deterioration of strength of a substrate paper or deterioration of material are caused, therefore, is not desirable.

Containing ratio of alkaline compound to a substrate paper is desirable to be decided suitably, because the ratio alters by grammage of a substrate paper, substitution ratio, blending ratio and sort of fibrous carboxy alkyl cellulose to be used. For example, in a case of sodium carbonate, 0.3-67 weight % to weight of the substrate paper, and in a case of sodium hydroxide, 0.2-51 weight % to weight of the substrate paper.

An alkalizing agent can be coated as an aqueous solution of above mentioned alkaline compound or as a mixture of said aqueous solution and aqueous organic solvent which has compatibility with said aqueous solution using an air knife coater, a bar coater, a roll coater, a blade coater, a curtain coater, a champflex coater or a gravure coater.

For the purpose to adjust the viscosity of said aqueous solution of alkaline compound to the level fitted to a coating machine to be used or to protect the falling of the alkaline compound after dried, water soluble polymer which has compatibility with said aqueous solution can be blended. As a water soluble polymer to be used, starch and starch derivatives, cellulose derivatives such as carboxy alkyl cellulose salts, alginic acid salt or polyacrylic acid salt can be mentioned.

Further, when water holding capacity of aqueous solution of alkaline compound is high (aqueous solution of alkaline compound is difficult to be impregnate in a substrate paper), since aqueous solution of alkaline compound becomes difficult to impregnate in whole substrate paper homogeneously, there is a tendency that the water dispersibility to deteriorate. On the contrary, when water holding capacity of aqueous solution of alkaline compound is low (aqueous solution of alkaline compound easily impregnates in a substrate paper), there is a possibility that the aqueous solution of alkaline compound effects to colorization thermally sensitive recording layer. Therefore, regarding aqueous solution of alkaline compound, it is desirable that water holding ability to a substrate paper is adjusted by a water holding agent. As an example of this water holding agent, starch and derivatives thereof, carboxy alkyl cellulose salt, hydroxyl alkyl cellulose, cellulose derivatives such as alkyl cellulose, natural polymer water holding agent such as alginic acid salt or Xanthan rubber, polyacrylic acid salt, polyvinyl alcohol, modified polyvinyl alcohol such as carboxy denatured polyvinyl alcohol, polyvinyl pyrroridone, gelatin or kasein can be mentioned, however, not limited to these compounds. In the present invention, water holding ability is a measured value of impregnated amount of a coating liquid (g/m²) into a substrate paper at certain pressure·temperature·time, and as an example of apparatus used for the measurement of the water holding ability, AA-GWR water retention meter Model 1250 (product of Kaltec Co. Ltd., measuring condition: Pressure; 5 Bar, time; 40 sec, amount of coating liquid; 20 ml, filter; GWR 420) can be mentioned.

A coating paper of the present invention is preferably used as a label. For example, adhered as a mailing indication label on a returnable container, and can be removed from the container only by washing off after delivered. Therefore, it can save a trouble to remove it by fingers, and the working effect of the returnable container can be improved.

An adhering sheet which uses a coating paper of the present invention is a sheet characterizing an adhesive layer to the opposite side of a coating layer (printing layer). As an adhesive which compose said adhesive layer, a water soluble or water re-dispersible adhesive, especially acrylic adhesives is desirably used.

As an example of acrylic adhesives, a copolymer composed of alkoxyalkylacrylate, styrene sulfonate and other copolymerisable monomer and a compound containing a copolymer of vinyl monomer containing carboxyl group such as (metha)acrylic acid and hydroxyl group containing monomer and other copolymerisable monomer which is use when need is arison. Further, as an example of water re-dispersible acrylic adhesive, a copolymer prepared by copolymerizing (metha)acrylic acid alkyl ester, vinyl monomer containing carboxyl group, vinyl monomer containing alkoxy group and other copolymerisable monomer which is used when need is arisen or a composition containing a copolymer prepared by copolymerizing vinyl monomer containing carboxylated rosin ester, vinyl monomer containing carboxyl group and water soluble vinyl monomer as a base polymer can be mentioned. Carboxyl group of these copolymers, can be a salt characterizing a part or whole part of which is neutralized by alkali, and alkali metal salt, amine salt or alkanolamine salt are desirably used.

To these acrylic adhesives a cross linking agent can be blended for the purpose to adjust adhering forth, water solubility or water dispersibility. These cross linking agents are not limited, and can be suitably chosen from the compounds which are conventionally used in an acrylic adhesives as a cross linking agent. For example, isocyanate cross linking agents such as 1,2-ethylenediisocyanate, epoxy cross linking agents such as diglycidilether, melamine resin, urea resin, dialdehydes, methylol polymer, metallic chelate compound, metallic alkoxide or metallic salt can be mentioned. Further, to said acrylic adhesives, public known plasticizing agent, adhering providing agent, coloring agent, thickner, defoaming agent, leveling agent, preservatives or antioxidation agent can be suitably blended. Regarding a plasticizing agent and an adhering providing agent, for example, a water soluble type or water dispersible type are desirable. And as a plasticizing agent, for example, polyhydric alcohol such as sugar alcohol, polyetherpolyol or alkanol amine salt of oxidized rosin can be mentioned. And as a adhering providing agent, for example, rosin, disproportionated rosin, alkali metal salt such as hydrogenated rosin, ammonium salt or polyether ester can be mentioned.

These adhesives can be coated directly to an alkalizing agent coated surface of a substrate paper and an adhesive agent layer can be provided, or after forming an adhesive agent layer on a surface of removing agent of a removing sheet by applying an adhesive agent, can transfer said layer to an alkalizing agent coated layer by sticking it to the alkalizing agent coated surface of the substrate paper. In any case, for the purpose to avoid unnecessary adhesion except actual use, a removable sheet is attached on the adhesive layer and can be used by removing it when desired. The coating amount of an adhesive layer provided on a substrate paper is 3-60 g/m² as a solid part, desirably 10-50 g/m². When coating amount of adhesive layer is smaller than 5 g/m², adhering ability of the obtained adhering sheet is not sufficient, on the contrary, when exceeds 60 g/m², adhesives becomes easily protrude at the preparation process of an adhesive sheet or in followed process and is not desirable.

Said removing sheet is not restricted, and conventional public known sheet, for example, paper substrate such as glassine paper, coating paper, cast coating paper, laminated paper prepared by laminating thermo plastic resin such as polyethylene to said paper substrate, or a various plastic film such as polyethyleneterephthalate, polypropylene or polyethylene to one surface or both surface of which a removing agent such as silicone resin is coated can be mentioned. Grammage of said removing sheet is not restricted, however, in general is 20-120 g m².

Coating of an adhesive can be carried out by printing method, and can be coated by pattern except edge part. In this case, on a removing sheet to be used removing agent can be partially coated corresponding to the coating pattern of the adhesive. Further, on the coating side surface of a coating paper which can be removed by water of the present invention, removing agent is partially coated by discontinuous pattern of a small point or rectangular shape, while on the surface of alkalizing agent, corresponding pattern to that of removing agent of adhesive, and by piling partially coated surface of adhesive and partially coated surface of removing agent, an adhesive sheet which does not need a removing sheet can be obtained.

The adhesive sheet of coating paper which can be removed by water of the present invention obtained as above, after stuck to a container, can be easily removed from the container by washing by water.

### EXAMPLE

The present invention will be illustrated more in detail according to Examples, however, not intending to restrict the scope of claims of the present invention to these Examples. Parts and % respectively indicate weight parts and weight %. In Examples, printability, removing (releasing) ability by water and water dispersibility are evaluated as mentioned below.

(Printability: Thermal Printer)

Printing is carried out using “Bar Cord Printer 140XiII” which is a product of Zebra Co., Ltd.

Printed part printed by 0.2 mJ thermal energy of thermal head and ground part of non-printed part are measured by “Macbeth RD-918” reflecting Densito Meter. Larger measured value of printed part means good color developing sensitivity and smaller measured value of non-printed part means less ground color fogging and is excellent and printing density is measured

(Printability: Ink-Jet Printer)

Full surface printing (black) is carried out on a specimen using “PM-970C” which is a product of Epson Co., Ltd., and printing density is measured by “Macbeth RD-918” reflecting Densito Meter. Further, a Japanese character [symbol] is printed using said printer by font 8 size and blotting of ink is evaluated by visual inspection according to following standard.

(Evaluation of Ink Blotting)

⊚: ink is not blotting

∘: ink is slightly blotting, however, discrimination of character is no problem

(Printability: Gravure Printing)

A gravure printer of Ministry of Finance type (Product of Kumagai Riki Industry Co., Ltd.) is used. Dots gravure block (175 lines) and ink for gravure printing is used and printing is carried out by 40 m/min printing speed and 10 kgf printing pressure. 10% dots part of the printed matter is inspected using a magnifying glass and failing numbers of dots are evaluated by visual inspection according to following standard.

(Evaluation of Dots Failing Number)

⊚: no failing part; very good level

∘: slightly failed part is observed but no problem level

(Removing Ability by Water)

To alkalizing agent layer surface of a specimen which is preserved in atmosphere of 23° C., 50% RH for 24 hour, kraft paper adhesive tape is adhered, then 5 pieces of specimen of 3 cm square are prepared. Then, 300 ml of de-ionized water is poured in 300 ml beaker and one piece of said specimen is thrown into the beaker stirring by 650 rpm using a stirrer. The time until the surface to which adhering tape is not adhered of the specimen removes forming a layer or fragmentary is measured by a stopwatch, and water removing time is obtained by averaging results from 5 tests. If water removing time is small, removing ability or water dispersing ability when contacted with water is excellent. When water removing time is 30 seconds or less, the removing ability by water is ranked to excellent (indicated by mark ⊚ in Table 1) and is 60 seconds or less, the removing ability by water is ranked to good (indicated by mark 0 in Table 1) and when exceed 60 seconds, the removing ability by water is ranked to non-removable (indicated by mark×in Table 1)

(Water Dispersing Ability)

From specimen which is preserved in atmosphere of 23° C., 50% RH for more than 24 hour, 5 pieces of fragment of specimen of 3 cm square are prepared. Then, 300 ml of de-ionized water is poured in 300 ml beaker and one piece of said specimen is thrown into the beaker stirring by 650 rpm using a stirrer. The time until the specimen breaks to two or more is measured by a stopwatch, and water dispersing time is obtained by averaging results from 5 tests. If the water dispersing time is small, the water dispersing ability is excellent. When water dispersing time is 30 seconds or less, the water dispersing time is ranked to excellent (indicated by mark ⊚ in Table 1) and is 60 seconds or less, the water dispersion time is ranked to good (indicated by mark ∘ in Table 1) and when exceed 60 seconds, the water dispersion time is ranked to insoluble (indicated by mark× in Table 1).

### Example 1

(Preparation of a Substrate Paper)

Paper manufacturing material in which 50 wt parts of conifer bleached kraft pulp beaten to 550 mlCSF Canadian freeness and 50 wt parts of conifer carboxy methyl cellulose (0.43 etherification degree) are blended is prepared, and a substrate paper of 55 g/m² grammage is manufactured using a cylinder paper machine with Yankee dryer (manufacturing speed; 40 m/min). Smoothness of a surface contacted to Yankee dryer is 7 s and smoothness of rear surface of the substrate paper is 3 s, and wet tensile strength to the length direction is 0.12 kN/m and does not have water dispersibility.

(Coating of an Under Layer)

A coating for under layer composed of 100 parts of calcined kaolin (product of XCI400 FECC, oil absorbing capacity is 70 ml), 0.2 parts of dispersing agent, 80 wt parts of 10% PVA aqueous solution and 50 parts of water is coated on a substrate paper using an air knife coater (coating speed: 200 m/min) and dried so as the dry weight to be 6 g/m², and an under layer is prepared.

(Coating of a Thermally Sensitive Recording Layer)

Then, a coating for a thermally sensitive recording layer composed of 36.0 parts of dispersion of color developing agent, 9.2 parts of dispersion of dye, 12.0 parts of sensitizer, 12.0 parts of calcium carbonate (Brilliant-15, product of Shiraishi Kogyo Co., Ltd., average Particle size=50% dispersion) is coated and dried (50° C.) using an air knife coater (coating speed: 200 m/min) so as the dry weight becomes 5 g/m² and a thermally sensitive layer is formed. Color developing agent dispersion, dye dispersion and sensitizer dispersion are prepared as follows.

(Color Developing Agent Dispersion)

18.8 parts of 10% aqueous solution of PVA, 6.0 parts of 4-hydroxy-4′-isopropoxydiphenylsulfone and 11.2 parts of water are dispersed and ground by average particle size 1 μm using a sand grinder.

(Dye Dispersion)

2.0 parts of 3-di-n-butylamino-6-methyl-7-anilinofluorane, 4.6 parts of 10% aqueous solution of PVA and 2.6 parts of water are dispersed and ground by average particle size 1 μm using a sand grinder.

(Sensitizer Dispersion)

4.0 parts of 4-biphenylp-tolylether, 5.0 parts of 10% aqueous solution of PVA and 3.0 parts of water are dispersed and ground by average particle size 1 μm using a sand grinder.

(Smoothing Treatment 1)

After the thermal sensitive recording layer is coated, smoothing treatment is carry out using a calendar so as the Beck smoothness of thermal sensitive recording layer surface becomes 200-300 sec.

(Impregnation of Alkalizing Agent)

Then, aqueous solution of 10 wt % sodium carbonate is coated and dried (40° C.) using an air knife coater (coating speed: 200 m/min) so as the dry weight becomes 5 g/m², coating amount of which becomes to correspond to 1.5 times of neutralization equivalent, and an alkalizing agent layer is impregnated in a substrate paper.

(Smoothing Treatment 2)

After said alkalizing agent layer is coated, smoothing treatment is carried out using a calendar so as the Beck smoothness of thermal sensitive recording layer surface becomes 200-300 sec, and a water decaying coating paper (thermally sensitive recording paper) of the present invention is obtained.

Physical properties of the obtained coating paper which can be removed by water obtained as above (printing ability, removing ability by water, water dispersibility) are evaluated. Results are shown in Table 1 and Table 2.

### Example 2

(Preparation of Substrate Paper)

Paper manufacturing material in which 5 wt parts of conifer bleached kraft pulp beaten to 550 mlCSF Canadian freeness and 95 wt parts of fibrous carboxymethyl cellulose (0.43 etherification degree) are blended is prepared, and a substrate paper of 55 g/m² grammage is manufactured using a cylinder paper machine with Yankee dryer paper manufacturing machine (manufacturing speed: 40 m/min). Smoothness of a surface contacted to Yankee dryer is 4 s and smoothness of rear surface of the substrate paper is 2 s, and wet tensile strength to the length direction is 0.14 kN/m and does not have water dispersibility.

By same process to Example 1 except using above substrate paper, a coating paper which can be removed by water is prepared and estimation results of physical properties are shown in Table 1 and Table 2.

### Example 3

(Preparation of Substrate Paper)

Paper manufacturing material in which 40 wt parts of conifer bleached kraft pulp beaten to 550 mlCSF Canadian freeness and 60 wt parts of fibrous carboxymethyl cellulose (0.43 etherification degree) are blended is prepared, and a substrate paper of 55 g/m² grammage is manufactured using a Yankee dryer paper manufacturing machine (manufacturing speed: 40 m/min). Smoothness of a surface contacted to Yankee dryer is 6 s and smoothness of rear surface of the substrate paper is 2 s, and wet tensile strength to the length direction is 0.14 kN/m and does not have water dispersibility.

By same process to Example 1 except using above substrate paper, a coating paper which can be removed by water is prepared and estimation results of physical properties are shown in Table 1 and Table 2.

### Example 4

(Preparation of Substrate Paper)

Paper manufacturing material in which 70 wt parts of conifer bleached kraft pulp beaten to 550 mlCSF Canadian freeness and 30 wt parts of fibrous carboxymethyl cellulose (0.43 etherification degree) are blended is prepared, and a substrate paper of 55 g/m² grammage is manufactured using a cylinder paper machine with Yankee dryer paper manufacturing machine (manufacturing speed: 40 m/min). Smoothness of a surface contacted to Yankee dryer is 12 s and smoothness of rear surface of the substrate paper is 3 s, and wet tensile strength to the length direction is 0.12 kN/m and does not have water dispersibility.

By same process to Example 1 except using above substrate paper, a coating paper which can be removed by water is prepared and estimation results of physical properties are shown in Table 1 and Table 2.

### Example 5

(Preparation of Substrate Paper)

Paper manufacturing material in which 80 wt parts of conifer bleached kraft pulp beaten to 550 mlCSF Canadian freeness and 20 wt parts of fibrous carboxymethyl cellulose (0.43 etherification degree) are blended is prepared, and a substrate paper of 55 g/m² grammage is manufactured using a cylinder paper machine with Yankee dryer paper manufacturing machine (manufacturing speed: 40 m/min). Smoothness of a surface contacted to Yankee dryer is 12 s and smoothness of rear surface of the substrate paper is 3 s, and wet tensile strength to the length direction is 0.12 kN/m and does not have water dispersibility.

By same process to Example 1 except using above substrate paper, a coating paper which can be removed by water is prepared and estimation results of physical properties are shown in Table 1 and Table 2.

### Example 6

(Preparation of Substrate Paper)

Paper manufacturing material in which 80 wt parts of conifer bleached kraft pulp beaten to 550 mlCSF Canadian freeness and 20 wt parts of fibrous carboxymethyl cellulose (0.43 etherification degree) are blended is prepared, and a substrate paper of 65 g/m² grammage is manufactured using a cylinder paper machine with Yankee dryer paper manufacturing machine (manufacturing speed: 40 m/min). Smoothness of a surface contacted to Yankee dryer is 12 s and smoothness of rear surface of the substrate paper is 3 s, and wet tensile strength to the length direction is 0.13 kN/m and does not have water dispersibility.

By same process to Example 1 except using above substrate paper, a coating paper which can be removed by water is prepared and estimation results of physical properties are shown in Table 1 and Table 2.

### Example 7

(Preparation of Substrate Paper)

Paper manufacturing material in which 50 wt parts of conifer bleached kraft pulp beaten to 550 mlCSF Canadian freeness and 50 wt parts of fibrous carboxy methyl cellulose (0.43 etherification degree) are blended is prepared, and a substrate paper of 65 g/m² grammage is manufactured using a cylinder paper machine with Yankee dryer paper manufacturing machine (manufacturing speed: 40 m/min). Smoothness of a surface contacted to Yankee dryer is 9 s and smoothness of rear surface of the substrate paper is 3 s, and wet tensile strength to the length direction is 0.13 kN/m and does not have water dispersibility.

By same process to Example 1 except using above substrate paper, a coating paper which can be removed by water is prepared and estimation results of physical properties are shown in Table 1 and Table 2.

### Example 8

(Preparation of Substrate Paper)

Paper manufacturing material in which 50 wt parts of conifer bleached kraft pulp beaten to 350 mlCSF Canadian freeness and 50 wt parts of fibrous carboxy methyl cellulose (0.43 etherification degree) are blended is prepared, and a substrate paper of 55 g/m² grammage is manufactured using a cylinder paper machine with Yankee dryer paper manufacturing machine (manufacturing speed: 40 m/min). Smoothness of a surface contacted to Yankee dryer is 14 s and smoothness of rear surface of the substrate paper is 3 s, and wet tensile strength to the length direction is 0.14 kN/m and does not have water dispersibility.

By same process to Example 1 except using above substrate paper, a coating paper which can be removed by water is prepared and estimation results of physical properties are shown in Table 1 and Table 2.

### Example 9

By same process to Example 1 except using potassium carbonate as an alkaline compound, a coating paper which can be removed by water of the present invention is prepared and estimation results of physical properties are shown in Table 1 and Table 2.

### Example 10

By same process to Example 1 except using 3 wt % aqueous solution of sodium hydroxide as an alkaline compound and coating amount is 2.6 g/m² by dry weight, a coating paper which can be removed by water of the present invention is prepared and estimation results of physical properties are shown in Table 1 and Table 2.

### Example 11

By same process to Example 1 except using ammonia as an alkaline compound, a coating paper which can be removed by water of the present invention is prepared and estimation results of physical properties are shown in Table 1 and Table 2.

### Example 12

By same process to Example 1 except using triethanolamine as an alkaline compound, a coating paper which can be removed by water of the present invention is prepared and estimation results of physical properties are shown in Table 1 and Table 2.

### Example 13

By same process to Example 1 except using polyethyleneimine whose molecular weight is 300 as an alkaline compound, a coating paper which can be removed by water of the present invention is prepared and estimation results of physical properties are shown in Table 1 and Table 2.

### Example 14

(Preparation of Substrate Paper)

A substrate paper of 55 g/m² grammage is manufactured by adhering a moisture paper A (dry grammage: corresponding to 10 g/m²) manufactured from paper manufacturing material composed of 75 wt % of broadleaf tree and 25 wt % of conifer bleached kraft pulp which are beaten to 550 mlCSF Canadian freeness and a moisture paper B (dry grammage: corresponding to 45 g/m²) manufactured from paper manufacturing material composed of 50 wt parts of conifer bleached kraft pulp beaten to 680 mlCSF Canadian freeness and 50 weight parts of fibrous carboxy methyl cellulose (0.43 etherification degree) using a cylinder paper machine with Yankee dryer having two cylinders (manufacturing speed: 40 m/min). Smoothness of a surface contacted to Yankee dryer is 12 s and smoothness of rear surface of the substrate paper is 3 s, and wet tensile strength to the length direction is 0.13 kN/m and does not have water dispersibility.

To the moisture paper A side surface of the substrate paper, an under layer and a thermally sensitive recording layer are coated, and to the moisture paper B side surface of the substrate paper, an alkalization agent is contained, then calendaring treatment is carried out, thus a thermally sensitive recording paper of the present invention is prepared and estimation results of physical properties are shown in Table 1 and Table 2.

### Example 15

(Preparation of Substrate Paper)

A substrate paper of 55 g/m grammage is manufactured by adhering a moisture paper A consisting of 75 wt % of broadleaf tree of 55 g/m² grammage is manufactured and 25 wt % of conifer bleached kraft pulp which are beaten to 550 mlCSF Canadian freeness (dry grammage: corresponding to 25 g/m²) and a moisture paper B manufactured from paper manufacturing material in which 50 wt parts of conifer bleached kraft pulp beaten to 680 mlCSF Canadian freeness and 50 wt parts of fibrous carboxy methyl cellulose (0.43 etherification degree) are blended (dry grammage: corresponding to 30 g/m²) using a cylinder paper machine with Yankee dryer having two cylinders (manufacturing speed: 40 m/min). Smoothness of a surface contacted to Yankee dryer is 12 s and smoothness of rear surface of the substrate paper is 3 s, and wet tensile strength to the length direction is 0.13 kN/m and does not have water dispersibility.

To the moisture paper A side surface of the substrate paper, an under layer and a thermally sensitive recording layer are coated, and to the moisture paper B side surface of the substrate paper, an alkalization agent is contained, then calendaring treatment is carried out, thus a coating paper which can be removed by water (thermally sensitive recording paper) of the present invention is prepared and estimation results of physical properties are shown in Table 1 and Table 2.

### Example 16

By same process to Example 1 except changing coating amount of alkalizing agent to 0.34 g/m² (dry weight) which is correspond to 10% of neutralization equivalent, a thermally sensitive recording paper is prepared.

Physical properties (printing ability, removing ability by water and water dispersibility) of the thermally sensitive recoding paper prepared as above are estimated and results are shown in Table 1 and Table 2.

### Example 17

By same process to Example 1 except changing coating amount of alkalizing agent to 6.70 g/m² (dry weight) which is correspond to 200% of neutralization equivalent, a thermally sensitive recording paper is prepared.

Physical properties (printing ability, removing ability by water and water dispersibility) of the thermally sensitive recoding paper prepared as above are estimated and results are shown in Table 1 and Table 2.

### Example 18

(Coating of a Protecting Layer)

On a thermally sensitive recording layer of the thermally sensitive recording paper of Example 1, a coating liquid containing 500 weight parts of aqueous solution polyvinyl alcohol containing aceto acetic acid ester group (product of Nippon Gose Kagaku Kogyo Co., Ltd., Commodity name “Gosefaimer Z200”) (solid part conc. is 10 wt %) and 80 weight parts of aqueous dispersion of calcium carbonate (solid part conc. is 30 wt %) is coated so as the dry weight becomes 1.5 g/m² using a wire rod coater by 300 m/min speed, and a protecting layer is formed.

(Coating of an Adhesive Layer)

100 weight parts water soluble emulsion type acrylic adhesive (product of Nippon Industries Co., Inc., Commodity name “Nikasol HS002” solid part conc.: 40 wt %) and 2 weight parts of epoxy resin cross linking agent (product of Nippon Carbide Industries Co., Inc., Commodity name “FX-931” solid part conc.: 10 wt %) are mixed and an adhesive coating liquid is prepared. Obtained adhesive coating liquid is coated on a removing surface of a removing sheet (product of Mishima Paper Co., Ltd., “35 SIP”, grammage: 36 g/m²) to which silicone removing agent is coated so as the coating amount as solid part to be 30 g/m² and dried, thus a adhesive layer is prepared. This adhesive layer is stuck with the surface of alkalizing agent layer side of the thermally sensitive recording paper to which above mentioned protective layer is formed, and a thermally sensitive recording paper with an adhesive layer is prepared.

Physical properties (printing ability, water removable ability, water dispersibility) of the coating paper which can be removed by water (thermally sensitive recording paper) prepared as above are estimated and results are shown in Table 1 and Table 2. Moreover, estimation of disentangling ability is estimated by barking a removing sheet.

### Example 19

(Preparation of Substrate Paper)

A substrate paper of 55 g/m² grammage is manufactured by adhering a moisture paper A (dry grammage: corresponding to 25 g/m²) manufactured from paper manufacturing material composed of 75 wt % of broadleaf tree and 25 wt % of conifer bleached kraft pulp which are beaten to 550 mlCSF Canadian freeness and a moisture paper B (dry grammage: corresponding to 30 g/m²) manufactured from paper manufacturing material composed of 50 wt parts of conifer bleached kraft pulp beaten to 650 mlCSF Canadian freeness and 50 wt parts of fibrous carboxy methyl cellulose (0.43 etherification degree) using a cylinder paper machine with Yankee dryer having two cylinders (manufacturing speed: 40 m/min). Smoothness of a surface contacted to Yankee dryer is 12 s and smoothness of rear surface of the substrate paper is 3 s, and wet tensile strength to the length direction is 0.13 kN/m and does not have water dispersibility.

To the moisture paper A side surface of the substrate paper a pigment layer mentioned below is coated, and to the moisture paper B side surface of the substrate paper an alkalizing agent is impregnated. After that, calendaring treatment is carried out and a coating paper which can be removed by water (ink jet recording medium) of the present invention is prepared. Estimation results are shown in Table 1 and Table 2.

(Coating of a Pigment Coating Layer)

To the moisture paper A side (smooth surface) of the substrate paper, a coating liquid for a pigment coating layer composed of 100 parts of silica (product of Tokuyama Corporation, commodity name: “Fainsil X37B”20% dispersion), 50 parts of 10% PVA solution and 2 parts of cationic resin (product of Seiko PMC Co., Ltd., die fixing agent, commodity name “SRD-150” 50%) is coated so as the dry weight to become 11 g/m² using a blade coater by 300 m/min speed, then dried and a pigment layer is formed.

(Impregnation of Alkalizing Agent)

Then, to the moisture paper B side of the substrate paper, 10 wt % conc. sodium carbonate aqueous solution is coated so as the coating amount to be 2.7 g/m² (dry weight) which corresponds to 1.5 times of a neutralizing equivalent using an air knife coater by coating speed 200 m/min and dried (40° C.), thus an alkalizing agent layer is impregnated in a substrate paper.

### Example 20

(Preparation of a Substrate Paper)

Paper manufacturing material in which 50 wt parts of conifer bleached kraft pulp beaten to 550 mlCSF Canadian freeness and 50 wt parts of fibrous carboxy methyl cellulose (0.43 etherification degree) are blended is prepared, and a substrate paper of 55 g/m² grammage is manufactured using a cylinder paper machine with Yankee dryer (manufacturing speed: 40 m/min). Smoothness of a surface contacted to Yankee dryer is 7 s and smoothness of rear surface of the substrate paper is 3 s, and wet tensile strength to the length direction is 0.12 kN/m and does not have water dispersibility.

(Coating of a Pigment Coating Layer)

70% pigment dispersion composed of 100 parts of kaolin (product of Imelis Co., Ltd., commodity name is “Premium”) and 0.2 parts of dispersing agent (sodium polyacrylate), and coating liquid for a pigment coating layer composed of 10.5 parts of 20% polyvinyl alcohol solution (product of Kuraray commodity name “PVA105”) and 2 parts of 35% solution of hydroxymethylated starch (commodity name “Penfordgam 295”) are coated on the surface of a substrate paper so as the dry weight to be 12 g/m² using a blade coater by 500 m/min speed and dried and a pigment coating layer is formed.

(Impregnation of Alkalizing Agent)

Then, to the moisture paper B side of the substrate paper, 10 wt % conc. sodium carbonate aqueous solution is coated so as the coating amount to be 2.7 g/m² (dry weight) which corresponds to 1.5 times of a neutralizing equivalent using an air knife coater by coating speed 200 m/min and dried (40° C.), thus an alkalizing agent layer is impregnated in a substrate paper.

(Smoothing Treatment)

After said alkalizing agent layer is coated, super calendar treatment is carried out by conditions of roller temperature: 65° C., two nips, calendar linear pressure: 150 kg/cm paper feeding speed: 10 m/min and a water decaying coating paper (paper for gravure printing) is obtained.

### Example 21

By same process to Example 1 except using a mixture of 100 parts of 10 wt % conc. aqueous solution of sodium carbonate and 10 parts of modified acrylic water holding agent (product of San Nopco Limited, commodity name SN Thickener 929-S, solid part is 12%) as an alkalizing agent layer and a thermally sensitive recording paper is prepared.

Physical properties (printing ability, removing ability by water and water dispersibility) of the thermally sensitive recoding paper prepared as above are estimated and results are shown in Table 1 and Table 2.

### Example 22

By same process to Example 1 except using a mixture of 100 parts of 10 wt % conc. aqueous solution of sodium carbonate and 30 parts of modified acrylic water holding agent (product of San Nopco Limited, commodity name SN Thickener 929-S, solid part is 12%) as an alkalizing agent layer and a thermally sensitive recording paper is prepared.

Physical properties (printing ability, removing ability by water and water dispersibility) of the thermally sensitive recoding paper prepared as above are estimated and results are shown in Table 1 and Table 2.

### Example 23

By same process to Example 1 except using a condensation compound containing 55% of 2,2′-methylenebis(4-t-butyl phenol) {that is, containing 55% of 2,2′-methylenebis(4-t-butyl phenol) and remaining is a condensation compound consisting of tri-nuclear condensation compound (29%), tetra-nuclear condensation compound (11%) and penta-nuclear condensation compound (4%) which is corresponding thereto and others is 1%) as a color developing agent, a thermally sensitive recording layer is prepared, and estimation results of physical properties are shown in Table 1 and Table 2.

### Example 24

By same process to Example 1 except using 3-(N-ethyl-N-isopentylamino)-6-methyl-7-anilinofluorane as a dye, a thermally sensitive recording paper of the present invention is prepared, and estimation results of physical properties are shown in Table 1 and Table 2

### Example 25

By same process to Example 1 except using 1,2-bis(3-methylphenoxy) ethane as a sensitizer, a thermally sensitive recording paper of the present invention is prepared, and estimation results of physical properties are shown in Table 1 and Table 2.

### Comparative Example 1

(Preparation of a Substrate Paper)

Paper manufacturing material in which 96 weight parts of conifer bleached kraft pulp beaten to 550 mlCSF Canadian freeness and 4 weight parts of fibrous carboxy methyl cellulose (0.43 etherification degree) are blended is prepared, and a substrate paper of 55 g/m² grammage is manufactured using a cylinder paper machine with Yankee dryer (manufacturing speed: 40 m/min). Smoothness of a surface contacted to Yankee dryer is 22 s and smoothness of rear surface of the substrate paper is 4 s, and wet tensile strength to the length direction is 0.14 kN/m and does not have water dispersibility.

By same process to Example 1 except using said substrate paper, a coating paper which can be removed by water is prepared, and estimation results of physical properties are shown in Table 1 and Table 2.

### Comparative Example 2

(Preparation of a Substrate Paper)

Paper manufacturing material is prepared by beating conifer bleached kraft pulp to 550 mlCSF Canadian freeness, and a substrate paper of 55 g/m 2 grammage is manufactured using a cylinder paper machine with Yankee dryer (manufacturing speed: 40 m/min). Smoothness of a surface contacted to Yankee dryer is 20 s and smoothness of rear surface of the substrate paper is 9 s, and wet tensile strength to the length direction is 0.12 kN/m and does not have water dispersibility.

By same process to Example 1 except using said substrate paper, a coating paper which can be removed by water is prepared, and estimation results of physical properties are shown in Table 1 and Table 2.

### Comparative Example 3

(Preparation of a Substrate Paper)

Paper manufacturing material is prepared by beating conifer bleached kraft pulp to 550 mlCSF Canadian freeness, and a substrate paper of 55 g/m² grammage is manufactured using a cylinder paper machine with Yankee dryer (manufacturing speed: 40 m/min). Smoothness of a surface contacted to Yankee dryer is 20 s and smoothness of rear surface of the substrate paper is 9 s, and wet tensile strength to the length direction is 0.12 kN/m and does not have water dispersibility.

By same process to Example 19 except using said substrate paper, a coating paper which can be removed by water is prepared, and estimation results of physical properties are shown in Table 1 and Table 2.

### Comparative Example 4

(Preparation of a Substrate Paper)

Paper manufacturing material in which 96 weight parts of conifer bleached kraft pulp beaten to 550 mlCSF Canadian freeness and 4 weight parts of fibrous carboxy methyl cellulose (0.43 etherification degree) are blended is prepared, and a substrate paper of 55 g/m² grammage is manufactured using a cylinder paper machine with Yankee dryer paper manufacturing machine (manufacturing speed: 40 m/min). Smoothness of a surface contacted to Yankee dryer is 22 s and smoothness of rear surface of the substrate paper is 4 s, and wet tensile strength to the length direction is 0.14 kN/m and does not have water dispersibility.

By same process to Example 20 except using said substrate paper, a coating paper which can be removed by water is prepared, and estimation results of physical properties are shown in Table 1 and Table 2.

### Comparative Example 5

By same process to Example 20 except using water soluble paper (product of Mishima Paper Co., Ltd., commodity name 60DMDP), coating liquid for an undercoat layer is tried to coated on a smooth surface of a substrate paper so as the dry weight to be 6 g/m² using a blade coater, however, the substrate paper is swelled by coating liquid for an undercoat layer and the substrate paper is broken, therefore the undercoat layer can not be formed. Further, a coating liquid for thermally sensitive recording layer is tried to coat on a smooth surface of a substrate paper without coating an undercoat layer so as the dry weight to be 5 g/m² using an air knife coater, however, the substrate paper is swelled by coating liquid for an undercoat layer and the substrate paper is broken, therefore the thermally sensitive layer can not be formed.

TABLE 1

| | pulp | | CMC | | | | | |
|---|---|---|---|---|---|---|---|---|
| | | blending | substitution | blending | | coating | alkalizing agent | |
| | freeness | amount | degree | amount | gramage | layer | sort | amount |
| Ex. 1 | 550 | 50 | 0.43 | 50 | 55 | thermal | Na₂CO₃ | 1.5 |
| Ex. 2 | 550 | 5 | 0.43 | 95 | 55 | thermal | Na₂CO₃ | 1.5 |
| Ex. 3 | 550 | 40 | 0.43 | 60 | 55 | thermal | Na₂CO₃ | 1.5 |
| Ex. 4 | 550 | 70 | 0.43 | 30 | 55 | thermal | Na₂CO₃ | 1.5 |
| Ex. 5 | 550 | 80 | 0.43 | 20 | 55 | thermal | Na₂CO₃ | 1.5 |
| Ex. 6 | 550 | 80 | 0.43 | 20 | 65 | thermal | Na₂CO₃ | 1.5 |
| Ex. 7 | 550 | 50 | 0.43 | 50 | 65 | thermal | Na₂CO₃ | 1.5 |
| Ex. 8 | 350 | 50 | 0.43 | 50 | 55 | thermal | Na₂CO₃ | 1.5 |
| Ex. 9 | 550 | 50 | 0.43 | 50 | 55 | thermal | Na₂CO₃ | 1.5 |
| Ex. 10 | 550 | 50 | 0.43 | 50 | 55 | thermal | K₂CO₃ | 1.5 |
| Ex. 11 | 550 | 50 | 0.43 | 50 | 55 | thermal | NaOH | 1.5 |
| Ex. 12 | 550 | 50 | 0.43 | 50 | 55 | thermal | ammonia | 1.5 |
| Ex. 13 | 550 | 50 | 0.43 | 50 | 55 | thermal | amines | 1.5 |
| Ex. 14 | 680 | 50 | 0.43 | 50 | 45 | thermal | imines | 1.5 |
| | 550 | 100 | — | — | 10 | | | |
| Ex. 15 | 680 | 50 | 0.43 | 50 | 30 | thermal | Na₂CO₃ | 1.5 |
| | 550 | 100 | — | — | 25 | | | |
| Ex. 16 | 550 | 50 | 0.43 | 50 | 55 | thermal | Na₂CO₃ | 0.1 |
| Ex. 17 | 550 | 50 | 0.43 | 50 | 55 | thermal | Na₂CO₃ | 2 |
| Ex. 18 | 550 | 50 | 0.43 | 50 | 55 | thermal/ | Na₂CO₃ | 1.5 |
| | | | | | | adhesive | | |
| Ex. 19 | 680 | 50 | 0.43 | 50 | 45 | ink jet | Na₂CO₃ | 1.5 |
| | 550 | 100 | — | — | 10 | | | |
| Ex. 20 | 550 | 50 | 0.43 | 50 | 55 | gravure | Na₂CO₃ | 1.5 |
| Ex. 21 | 550 | 50 | 0.43 | 50 | 55 | thermal | Na₂CO₃ | 1.5 |
| Ex. 22 | 550 | 50 | 0.43 | 50 | 55 | thermal | Na₂CO₃ | 1.5 |
| Ex. 23 | 550 | 50 | 0.43 | 50 | 55 | thermal | Na₂CO₃ | 1.5 |
| Ex. 24 | 550 | 50 | 0.43 | 50 | 55 | thermal | Na₂CO₃ | 1.5 |
| Ex. 25 | 550 | 50 | 0.43 | 50 | 55 | thermal | Na₂CO₃ | 1.5 |
| Co. Ex. 1 | 550 | 96 | 0.43 | 4 | 55 | thermal | Na₂CO₃ | 1.5 |
| Co. Ex. 2 | 550 | 100 | — | — | 55 | thermal | Na₂CO₃ | 1.5 |
| Co. Ex. 3 | 550 | 100 | — | — | 55 | ink jet | Na₂CO₃ | 1.5 |
| Co. Ex. 4 | 550 | 96 | 0.43 | 4 | 55 | gravure | Na₂CO₃ | 1.5 |

| | | | | | |
|---|---|---|---|---|---|
| Co. Ex. 5 | water soluble paper in the market | 60 | — | Na₂CO₃ | — |

CMC: carboxy methyl cellulose
Co. Ex.: Comparative Example
amines is triethanol amine and imines is polyethylene imine.

TABLE 2

| | | printing ability | | | | |
|---|---|---|---|---|---|---|
| | | thermal | | printing ability | | printing |
| | quality | ground | image | ink jet | | ability |
| | solubility | part | part | density | fogging | gravure |
| Ex. 1 | ⊚ | 0.07 | 1.41 | — | — | — |
| Ex. 2 | ⊚ | 0.07 | 1.38 | — | — | — |
| Ex. 3 | ⊚ | 0.08 | 1.40 | — | — | — |
| Ex. 4 | ⊚ | 0.07 | 1.42 | — | — | — |
| Ex. 5 | ◯ | 0.08 | 1.42 | — | — | — |
| Ex. 6 | Δ | 0.07 | 1.41 | — | — | — |
| Ex. 7 | ⊚ | 0.07 | 1.40 | — | — | — |
| Ex. 8 | Δ | 0.08 | 1.43 | — | — | — |
| Ex. 9 | ⊚ | 0.07 | 1.40 | — | — | — |
| Ex. 10 | ⊚ | 0.07 | 1.38 | — | — | — |
| Ex. 11 | ⊚ | 0.08 | 1.41 | — | — | — |
| Ex. 12 | ⊚ | 0.07 | 1.41 | — | — | — |
| Ex. 13 | ⊚ | 0.07 | 1.40 | — | — | — |
| Ex. 14 | ◯ | 0.07 | 1.42 | — | — | — |
| Ex. 15 | Δ | 0.07 | 1.41 | — | — | — |
| Ex. 16 | Δ | 0.07 | 1.43 | — | — | — |
| Ex. 17 | ⊚ | 0.08 | 1.38 | — | — | — |
| Ex. 18 | ⊚ | 0.07 | 1.33 | — | — | — |
| Ex. 19 | ◯ | — | — | 1.72 | ⊚ | — |
| Ex. 20 | ⊚ | — | — | — | — | ⊚ |
| Ex. 21 | ⊚ | 0.07 | 1.47 | — | — | — |
| Ex. 22 | ◯ | 0.07 | 1.48 | — | — | — |
| Ex. 23 | ⊚ | 0.07 | 1.42 | — | — | — |
| Ex. 24 | ⊚ | | 1.40 | — | — | — |
| Ex. 25 | ⊚ | 0.07 | 1.43 | — | — | — |
| Co. Ex. 1 | X | 0.07 | 1.45 | — | — | — |
| Co. Ex. 2 | X | 0.07 | 1.44 | — | — | — |
| Co. Ex. 3 | X | — | — | 1.75 | ◯ | — |
| Co. Ex. 4 | X | — | — | | | ◯ |
| Co. Ex. 5 | — | — | — | — | — | — |

Co. Ex.: Comparative Example

### POSSIBILITY FOR INDUSTRIAL USE

The coating paper of this invention has characteristics which thermally sensitive layer can be easily removed and dispersed by contact with water, besides printing aptitude, and can be used preferably for uses of a label for a returnable container.

What is claimed is:

1. A coating paper which can be removed by water, comprising a substrate paper of single layer or of lamellar structure having two or more layers which has at least one water decaying layer containing 5-100 wt % of water insoluble fibrous carboxy alkyl cellulose and at least one layer of water base color coated on said substrate paper, further comprising said substrate paper contains an alkalizing agent.

2. The coating paper which can be removed by water of claim 1, wherein said water decaying layer contains 30-60 wt % of fibrous carboxy alkyl cellulose and 40-70 wt % of water dispersible fibers to be used for paper manufacturing which is beaten to 550-650 mlCSF measured by Canadian standard freeness in conformity with JIS P8121, further grammage of the substrate paper is 50 g/m² or more.

3. The coating paper which can be removed by water of claim 1, wherein the alkalizing agent is at least one selected from the group consisting of hydroxide of alkali metal, alkali metal salt, ammonia, amines and imines, further, amount of said alkalizing agent is equal to a neutralization equivalent of fibrous carboxy alkyl cellulose contained in water decaying layer or more.

4. The coating paper which can be removed by water of claim 2, wherein the alkalizing agent is at least one selected from the group consisting of hydroxide of alkali metal, alkali metal salt, ammonia, amines and imines, further, amount of said alkalizing agent is equal to a neutralization equivalent of fibrous carboxy alkyl cellulose contained in water decaying layer or more.

5. The coating paper which can be removed by water of claim 1, further comprising, coating a water base color containing colorless or pale colored electron-donating leuco dye and electron-accepting color developing agent as main components.

6. The coating paper which can be removed by water of claim 2, further comprising, coating a water base color containing colorless or pale colored electron-donating leuco dye and electron-accepting color developing agent as main components.

7. The coating paper which can be removed by water of claim 3, further comprising, coating a water base color containing colorless or pale colored electron-donating leuco dye and electron-accepting color developing agent as main components

8. The coating paper which can be removed by water of claim 4, further comprising, coating a water base color containing colorless or pale colored electron-donating leuco dye and electron-accepting color developing agent as main components.

9. The coating paper which can be removed by water of claim 1, further comprising, coating or adhering an adhesive agent layer on a non-coating surface of the substrate paper.

10. The coating paper which can be removed by water of claim 2, further comprising, coating or adhering an adhesive agent layer on a non-coating surface of the substrate paper.

11. The coating paper which can be removed by water of claim 3, further comprising, coating or adhering an adhesive agent layer on a non-coating surface of the substrate paper.

12. The coating paper which can be removed by water of claim 4, further comprising, coating or adhering an adhesive agent layer on a non-coating surface of the substrate paper.

13. The coating paper which can be removed by water of claim 5, further comprising, coating or adhering an adhesive agent layer on a non-coating surface of the substrate paper.

14. The coating paper which can be removed by water of claim 6, further comprising, coating or adhering an adhesive agent layer on a non-coating surface of the substrate paper.

15. The coating paper which can be removed by water of claim 7, further comprising, coating or adhering an adhesive agent layer on a non-coating surface of the substrate paper.

16. The coating paper which can be removed by water of claim 8, further comprising, coating or adhering an adhesive agent layer on a non-coating surface of the substrate paper.

17. A method for preparation of a coating paper which can be removed by water, comprising, coating a water base color on one surface of a substrate paper of single layer or of lamellar structure having two or more layers which has at least one water decaying layer containing 5-100 wt % of water insoluble fibrous carboxy alkyl cellulose, then impregnating an alkalizing agent from a non-coating surface.

18. The method for preparation of the coating paper which can be removed by water of claim 17, coating a water base color on one surface of the substrate paper, then impregnating an alkalizing agent from a non-coating surface and coating or adhering an adhesive layer on the surface to which an alkalizing agent is impregnated.
